(19) United States
(12) Patent Application Publication
(10) Pub. No.: US 2004/0048532 A1
(43) Pub. Date: Mar. 11, 2004

(54) Nonwoven substrate which can give off an aroma and/or a flavor

(75) Inventor: Michel Tharreau, Angers (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tharreau Industries, Chemille (FR)

(21) Appl. No.: 10/219,111

(22) Filed: Aug. 14, 2002

(51) Int. Cl. B32B 3/00

(52) U.S. Cl. 442/59

(57) ABSTRACT

A nonwoven substrate which can give off an aroma and/or a flavor, in particular when moistened and a process for the manufacture of this substrate are provided. The substrate can be obtained by a process comprising a stage of thermal attachment of cyclodextrin particles to the nonwoven. It is particularly used for preparing dental or medical compresses.

### BACKGROUND OF THE INVENTION

The present invention relates to a nonwoven substrate which can give off an aroma and/or a flavor, in particular by moistening, which can be used in particular to prepare dental or medical compresses.

It is known to use cyclodextrins in a nonwoven for improving the adsorption properties of the latter.

Thus, French Patent Application No. 2 789 704 provides a process for the treatment of a fibre or a material, such as a nonwoven, comprising the following successive operations:

a) application of a solid mixture of cyclodextrin(s) and/or of cyclodextrin derivative(s), of at least one poly(carboxylic) acid and optionally of a catalyst;

b) heating to a temperature of between 150° C. and 220° C.;

c) washing with water; and

d) drying.

It is also known to use complexes of cyclodextrin and of fragrance for treating fabrics for the purpose of slowing down the diffusion of the fragrance and/or of controlling the diffusion thereof when the fabric is moistened.

Thus, European Patent Application No. 392 607 relates to a combination composed:

of a fabric conditioning composition, comprising a softening agent, an effective amount of fragrance/cyclodextrin complex and a clay-based agent for controlling the viscosity; and

of distribution means for distributing an effective amount of fabric conditioning composition over the fabric in a dryer operating at automatic drying temperatures, for example from 35 to 115° C.

Finally, International Application No. WO 99/21532 has, as subject-matter, a conditioning and rinsing product for personal and sole use which deposits, on the skin or the hair, materials which can be removed by rinsing and which exhibits satisfactory properties of releasing a fragrance, this product comprising:

(A) a water-insoluble substrate,

(B) at least one foaming surfactant added to the substrate or impregnating the substrate,

(C) from 0.015% to 15% by weight of the insoluble substrate of a complex which releases the fragrance, which complex is added to the substrate or impregnates the substrate, this complex comprising

(i) from 10 to 90% by weight of the complex of a porous support for a compound releasing the fragrance, it being possible for this support to be a cyclodextrin, and

(ii) from 1 to 90% by weight of the complex of the compound releasing the fragrance, this compound impregnating the support,

this product being essentially dry before the use thereof.

None of these documents discloses or suggests a nonwoven substrate which can be used in the dental, medical or surgical field.

### SUMMARY OF THE INVENTION

The invention consequently provides a nonwoven substrate which can give off an aroma and/or a flavor and which can be obtained by a process comprising a stage of thermal attachment of cyclodextrin particles to the nonwoven.

The cyclodextrin preferably chosen from the group consisting of α-, β- and/or γ-cyclodextrins and their mixtures and is preferably a β-cyclodextrin.

Such a nonwoven substrate has the advantage of being able to give off an aroma and/or a flavor by subsequent moistening on contact with water or, in the case of oral use, on contact with saliva.

According to a first aspect of the invention, the nonwoven is manufactured according to a first manufacturing process, by an immersion process. This process comprises the following stages:

a) immersion of the nonwoven substrate in an aqueous bath or coating with a paste or a foam, the said aqueous bath or the said paste or foam comprising at least suspended cyclodextrin particles, these particles comprising at least one substance which gives off an aroma and/or a flavor;

b) removing the nonwoven substrate from the bath or halting of the coating;

c) rolling the nonwoven substrate;

d) thermal attachment of the cyclodextrin particles.

According to a second aspect of the invention, the nonwoven is manufactured according to a second manufacturing process, a coating process. This process comprises the following stages:

a) coating with a powder comprising at least cyclodextrin particles comprising at least one substance which gives off an aroma and/or a flavor;

b) spraying water over the coated substrate;

c) thermal attachment of the cyclodextrin particles.

The invention also relates to these first and second processes.

Other characteristics and advantages of the invention will now be described in detail in the account which follows.

### DETAILED DESCRIPTION OF PREFERRED EMBODIMENTS

According to the invention, the starting nonwoven substrate can be composed of materials chosen from natural or synthetic materials.

It is generally composed of synthetic or natural fibres or of a mixture of these fibres.

Mention may be made, as natural fibres, of, for example, silk, keratin or cellulose fibres and their mixtures.

Mention may be made, as synthetic fibres, of, for example, acetate, acrylic, cellulose ester, polyamide, polyester, polyolefin, poly(vinyl alcohol), rayon or polyurethane foam fibres and their mixtures.

The starting nonwoven substrate is immersed in an aqueous bath comprising at least cyclodextrin particles. It can also be coated with a powder or a paste comprising cyclodextrin particles.

Use may be made, as cyclodextrin, of any cyclodextrin or any cyclodextrin derivative or any mixture of cyclodextrins and/or of cyclodextrin derivatives which can form complexes by inclusion of one or more substances which give(s) off an aroma and/or a flavor. Mention may therefore be made of cyclodextrins, such as unsubstituted cyclodextrins comprising from 6 to 12 glucose units, in particular α-, β- and/or γ-cyclodextrins, and/or their derivatives.

Cyclodextrin derivatives are disclosed, for example, in U.S. Pat. Nos. 3,426,011, 3,453,257, 3,453,258, 3,453,529, 3,453,260, 3,459,731, 3,553,191, 3,565,887, 4,535,152, 4,616,008, 4,638,058, 4,746,734 and 4,678,598.

Individual cyclodextrins can also be bonded to one another using multifunctional agents to form oligomers, polymers, copolymers, and the like.

It is also possible to use mixtures of cyclodextrins for the purpose of forming mixtures of complexes. Such mixtures can provide aroma and/or flavor profiles by trapping several substances which give off a flavor and/or an aroma and/or by preventing the formation of larger crystals of such complexes. Mixtures of cyclodextrins can be obtained according to the teachings of U.S. Pat. Nos. 3,425,910, 3,812,011, 4,317,881, 4,418,144 and 4,738,923.

Preferably, use is made essentially of a cyclodextrin, such as α-, β- and/or γ-cyclodextrins and very especially a β-cyclodextrin.

According to the invention, the cyclodextrin particles comprise at least one substance which gives off an aroma and/or a flavor.

The substance which gives off an aroma and/or a flavor can be chosen from fragrances and cooling agents.

The term cooling agents is understood to mean, in the present account, compounds which act on the nerve endings, leading to sensations of heat or of cold. Mention may in particular be made, as cooling agents, of menthol, its derivatives and the mixtures of these compounds.

Generally, the substance which gives off an aroma and/or a flavor is present in the cyclodextrin particles by the formation of a complex between the cyclodextrin and the substance or substances which give(s) off an aroma and/or a flavor.

The formation of such a complex is carried out in a way known to a person skilled in the art. The complex is usually formed by bringing the cyclodextrin and the substance which gives off an aroma and/or a flavor into contact in the form of solutions or suspensions in appropriate solvents, preferably water, or by milling the compounds in a minimum of solvent.

The formation of the complex can take place as stage preliminary to the process for the manufacture of the nonwoven substrate according to the invention.

Once the immersion of the nonwoven substrate in the aqueous bath of cyclodextrins has been carried out, the substrate is removed and it is rolled between two rollers, which makes it possible to monitor and adjust the amount of cyclodextrin suspension carried away and to remove the excess amounts of suspension.

The nonwoven substrate according to the invention obtained in this way therefore has the advantageous property of subsequently giving off, for example by moistening, an aroma and/or a flavor.

The subsequent moistening can take place by contact with water.

It can also take place on contact with saliva. Thus, when its constituents are all of the food type, the nonwoven according to the invention can find an application as medical compress for oral use.

### EXAMPLES

The following examples illustrate the present invention without, however, limiting the scope thereof.

### Example 1

A nonwoven substrate, from which was prepared a nonwoven dental compress with a menthol taste, was manufactured by employing the process according to the invention (by immersion).

### Example 2

A food soup sample was applied to a nonwoven substrate according to the invention obtained by the process (by coating) according to the invention.

What is claimed is:

1. A nonwoven substrate which can give off an aroma and/or a flavor and which can be obtained by a process comprising a stage of thermal attachment of cyclodextrin particles to the nonwoven.

2. The nonwoven substrate according to claim 1 which can be obtained by a process comprising the following stages:
a) immersion of a nonwoven substrate in an aqueous bath or coating with a paste or a foam, the said aqueous bath or the said paste or foam comprising at least suspended cyclodextrin particles, these particles comprising at least one substance which gives off an aroma and/or a flavor;
b) removing the nonwoven substrate from the bath or halting of the coating;
c) rolling the nonwoven substrate;
d) thermal attachment of the cyclodextrin particles.

3. The nonwoven substrate according to claim 1 which can be obtained by a process comprising the following stages:
a) coating with a powder comprising at least cyclodextrin particles comprising at least one substance which gives off an aroma and/or a flavor;
b) spraying water over the coated substrate;
c) thermal attachment of the cyclodextrin particles.

4. The nonwoven substrate according to claim 1, in which the cyclodextrin is chosen from the group consisting of α-, β- and/or γ-cyclodextrins and their mixtures and is preferably a β-cyclodextrin.

5. The nonwoven substrate according to claim 1, wherein the substance which gives off an aroma and/or a flavor is chosen from the group consisting of menthol, its derivatives and the mixtures of these compounds.

6. The nonwoven substrate according to claim 2, wherein the substance which gives off an aroma and/or a flavor is chosen from the group consisting of menthol, its derivatives and the mixtures of these compounds.

7. The nonwoven substrate according to claim 3, wherein the substance which gives off an aroma and/or a flavor is chosen from the group consisting of menthol, its derivatives and the mixtures of these compounds.

8. The nonwoven substrate according to claim 4, wherein the substance which gives off an aroma and/or a flavor is chosen from the group consisting of menthol, its derivatives and the mixtures of these compounds.

9. A process for the manufacture of a nonwoven substrate which can give off an aroma and/or a flavor and which can be obtained by a process comprising a stage of thermal attachment of cyclodextrin particles to the nonwoven, comprising the following stages:
a) immersion of a nonwoven substrate in an aqueous bath or coating with a paste or a foam, the said aqueous bath or the said paste or foam comprising at least suspended cyclodextrin particles, these particles comprising at least one substance which gives off an aroma and/or a flavor;
b) removing the nonwoven substrate from the bath or halting of the coating;
c) rolling the nonwoven substrate;
d) thermal attachment of the cyclodextrin particles.

10. A process for the manufacture of a nonwoven substrate which can give off an aroma and/or a flavor and which can be obtained by a process comprising a stage of thermal attachment of cyclodextrin particles to the nonwoven, comprising the following stages:
a) coating with a powder comprising at least cyclodextrin particles comprising at least one substance which gives off an aroma and/or a flavor;
b) spraying water over the coated substrate;
c) thermal attachment of the cyclodextrin particles.

11. The process according to claim 9, comprising a preliminary stage of formation of a complex between the cyclodextrin particles and at least one substance which gives off an aroma and/or a flavor.

12. The process according to claim 10, comprising a preliminary stage of formation of a complex between the cyclodextrin particles and at least one substance which gives off an aroma and/or a flavor.
